(19) United States
(12) Patent Application Publication
(10) Pub. No.: US 2013/0070133 A1
(43) Pub. Date: Mar. 21, 2013

(54) SOLID-STATE IMAGING DEVICE, IMAGING DEVICE, AND SIGNAL READING METHOD

(71) Applicant: OLYMPUS CORPORATION, Tokyo (JP)

(72) Inventor: Naohiro Takazawa, Tokyo (JP)

(73) Assignee: OLYMPUS CORPORATION, Tokyo (JP)

(21) Appl. No.: 13/680,492

(22) Filed: Nov. 19, 2012

(30) Foreign Application Priority Data
May 25, 2011 (JP) 2011-117170

(51) Int. Cl. H04N 5/335

(52) U.S. Cl. CPC H04N 5/335
USPC 348/294

(57) ABSTRACT

Provided are a solid-state imaging device, an imaging device, and a signal reading method, which may reduce the degradation of signal quality, suppress an increase in a chip area, and suppress an increase in current consumption. The solid-state imaging device includes a plurality of pixels classified as first to n^{th} (where n is an integer greater than or equal to 2) pixels, wherein each of the plurality of pixels includes a photoelectric conversion element arranged on a first substrate, an amplification circuit configured to output an amplified signal by amplifying a signal generated by the photoelectric conversion element, and a signal accumulation circuit arranged on a second substrate and configured to accumulate the amplified signal output from the amplification circuit, and a control unit configured to control a drive current to be exclusively supplied to the amplification circuit of each of the first to n^{th} pixels.

### BACKGROUND OF THE INVENTION

1. Field of the Invention

The present invention relates to a solid-state imaging device and an imaging device having electrically connected a first substrate and a second substrate on which circuit elements constituting pixels are arranged. In addition, the present invention relates to a signal reading method of reading signals from pixels.

2. Description of Related Art

Recently, video cameras, electronic still cameras, and the like have become generally widespread. In such cameras, a charge coupled device (CCD) or amplification type solid-state imaging device is used. The amplification type solid-state imaging device guides signal charges generated and accumulated by a photoelectric conversion unit of a pixel on which light is incident to an amplification unit provided in the pixel, and outputs the signal amplified by the amplification unit from the pixel. In the amplification type solid-state imaging device, a plurality of pixels are arranged in a two-dimensional (2D) matrix. An example of the amplification type solid-state imaging device includes a complementary metal oxide semiconductor (CMOS) type solid-state imaging device using a CMOS transistor or the like.

In the related art, a general CMOS type solid-state imaging device adopts a scheme (rolling shutter scheme) of sequentially reading signal charges generated by photoelectric conversion units of pixels arranged in a 2D matrix for each row. In this scheme, because the timing of exposure in the photoelectric conversion unit of each pixel is determined by the start and end of reading of the signal charges, the exposure timing is different for each row.

A simultaneous imaging function (global shutter function) for implementing the simultaneity of signal charge accumulation has been proposed. In addition, there is a growing demand for a CMOS type solid-state imaging device having the global shutter function. In the CMOS type solid-state imaging device having the global shutter function, it is generally necessary to provide an accumulation capacitor unit having light shielding properties so as to accumulate signal charges generated by the photoelectric conversion unit until the signal charges are read. After all pixels are simultaneously exposed to light, the CMOS type solid-state imaging device of the related art as described above simultaneously transfers signal charges generated by photoelectric conversion units in all the pixels to accumulation capacitor units, temporarily accumulates the signal charges in the accumulation capacitor units, and reads a pixel signal by sequentially converting the signal charges into the pixel signal at a predetermined reading timing.

A solid-state imaging device in which a metal oxide semiconductor (MOS) image sensor chip having a micro pad formed on a wiring layer side for each unit cell and a signal processing chip having a micro pad formed on a wiring layer side of a position corresponding to the micro pad of the MOS image sensor chip are connected by a micro bump is disclosed in Japanese Patent Application Publication No. 2006-49361. In addition, a method of preventing an increase in a chip area according to a solid-state imaging device in which a first substrate on which a photoelectric conversion unit is formed and a second substrate on which a plurality of MOS transistors are fowled are bonded is disclosed in Japanese Unexamined Patent Application, First Publication No. 2010-219339.

In Japanese Unexamined Patent Application, First Publication No. 2006-49361, there is a configuration in which a cell of the MOS image sensor chip includes a photoelectric conversion element, an amplification transistor, and the like (FIGS. 5 and 12 of Japanese Unexamined Patent Application, First Publication No. 2006-49361) and a cell of the signal processing chip converts a signal output from the cell of the MOS image sensor chip into a digital signal and then stores the digital signal in a memory (FIGS. 8 and 9 of Japanese Unexamined Patent Application, First Publication No. 2006-49361).

In Japanese Patent Application Publication No. 2010-219339, circuit elements constituting pixels having the global shutter function of the related art are divided and arranged on two substrates (FIG. 9 of Japanese Patent Application Publication No. 2010-219339).

### SUMMARY OF THE INVENTION

In accordance with a first aspect of the present invention, there is provided a solid-state imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification circuit configured to output an amplified signal by amplifying a signal generated by the photoelectric conversion element, and a signal accumulation circuit arranged on the second substrate and configured to accumulate the amplified signal output from the amplification circuit; and a control unit configured to control a drive current to be exclusively supplied to the amplification circuit of each of the first to n^{th} pixels.

In accordance with a second aspect of the present invention, in the solid-state imaging device according to the first aspect, the plurality of pixels are classified as the first to n^{th} pixels based on arrangement positions of the plurality of pixels.

In accordance with a third aspect of the present invention, in the solid-state imaging device according to the second aspect, the plurality of pixels are arranged in a matrix, the plurality of pixels are classified into one or more groups for each column, and pixels within the same group are classified as the first to n^{th} pixels.

In accordance with a fourth aspect of the present invention, in the solid-state imaging device according to the second aspect, further includes: a reset circuit configured to reset the photoelectric conversion element, wherein, the plurality of pixels are arranged in a matrix, and the signal accumulation circuit sequentially performs an operation of accumulating the amplified signal corresponding to the signal generated by the photoelectric conversion element in unit of row after the reset circuit has reset the photoelectric conversion element.

In accordance with a fifth aspect of the present invention, the solid-state imaging device according to the fourth aspect further includes: an output circuit configured to output the amplified signal accumulated in the signal accumulation circuit from the pixel, wherein, after amplified signals have been transferred to signal accumulation circuits of all pixels, the output circuit sequentially performs an operation of outputting the amplified signals from the pixels in unit of row.

In accordance with a sixth aspect of the present invention, in the solid-state imaging device according to the fourth aspect, the control unit selects one of the first to n^{th} pixels and turns on a drive current for the amplification circuit in the selected pixel during at least one period of a period in which the photoelectric conversion element generates the signal after the reset and a period in which the signal accumulation circuit accumulates the amplified signal corresponding to the signal generated by the photoelectric conversion element, and controls the drive current for the amplification circuit to be turned off during a period in which the amplified signal is output from the pixel.

In accordance with a seventh aspect of the present invention, in the solid-state imaging device according to the sixth aspect, the control unit has a first changeover switch connected to an output unit of the amplification circuit and a ground, and configured to switch ON and OFF of the connection between the output unit of the amplification circuit and the ground.

In accordance with an eighth aspect of the present invention, in the solid-state imaging device according to the seventh aspect, the first changeover switch turns on the connection between the output unit of the amplification circuit and the ground when the drive current for the amplification circuit is turned on, and turns off the connection between the output unit of the amplification circuit and the ground when the drive current for the amplification circuit is turned off.

In accordance with a ninth aspect of the present invention, in the solid-state imaging device according to the sixth aspect, the amplification circuit is connected to a row signal line arranged for each row, and the control unit has a second changeover switch connected to a power supply for supplying a voltage and the row signal line and configured to switch ON and OFF of a connection between the power supply and the row signal line.

In accordance with a tenth aspect of the present invention, in the solid-state imaging device according to the ninth aspect, the second changeover switch turns on a connection between the power supply and the row signal line when a drive current for the amplification circuit is turned on, and turns off the connection between the power supply and the row signal line when the drive current for the amplification circuit is turned off.

In accordance with an eleventh aspect of the present invention, in the solid-state imaging device according to the sixth aspect, the control unit includes: a third changeover switch connected to an input unit of the amplification circuit and a ground and configured to switch ON and OFF of a connection between the input unit of the amplification circuit and the ground.

In accordance with a twelfth aspect of the present invention, in the solid-state imaging device according to the eleventh aspect, the third changeover switch turns off the connection between the input unit of the amplification circuit and the ground when the drive current for the amplification circuit is turned on, and turns on the connection between the input unit of the amplification circuit and the ground when the drive current for the amplification circuit is turned off.

In accordance with a thirteenth aspect of the present invention, in the solid-state imaging device according to the sixth aspect, the amplification circuit is connected to a column signal line arranged for each column, wherein the column signal line is connected to a current source for supplying the drive current, and the control unit has a fourth changeover switch connected to an output unit of the amplification circuit and the column signal line and configured to switch ON and OFF of a connection between the output unit of the amplification circuit and the column signal line.

In accordance with a fourteenth aspect of the present invention, in the solid-state imaging device according to the thirteenth aspect, the fourth changeover switch turns on the connection between the output unit of the amplification circuit and the column signal line when the drive current for the amplification unit is turned on, and turns off the connection between the output unit of the amplification circuit and the column signal line when the drive current for the amplification unit is turned off.

In accordance with a fifteenth aspect of the present invention, there is provided a solid-state imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a first switching transistor having one of a source and a drain connected to the output terminal of the amplification transistor and the other of the source and the drain connected to a ground, and configured to switch ON and OFF of a connection between the output terminal of the amplification transistor and the ground and exclusively supply a drive current to the amplification transistor within each of the first to n^{th} pixels.

In accordance with a sixteenth aspect of the present invention, the solid-state imaging device according to the 15th aspect further includes a clamping capacitor configured to clamp the amplified signal output from the amplification transistor, and a transistor configured to receive a signal corresponding to the amplified signal clamped by the clamping capacitor using one of the source and the drain and accumulate the signal received using one of the source and the drain in the memory circuit by sampling and holding the signal.

In accordance with a seventeenth aspect of the present invention, in the solid-state imaging device according to the sixteenth aspect, the first substrate and the second substrate are electrically connected via a connection unit.

In accordance with an eighteenth aspect of the present invention, in the solid-state imaging device according to the seventeenth aspect, the connection unit is arranged between the photoelectric conversion element and the amplification transistor, between the amplification transistor and the clamping capacitor, between the clamping capacitor and the transistor, or between the transistor and the memory circuit on a path electrically connected from the photoelectric conversion element to the memory circuit.

In accordance with a nineteenth aspect of the present invention, there is provided a solid-state imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor connected to a row signal line arranged for each row and configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a changeover switch having one end connected to a power supply for supplying a voltage and the other end connected to the row signal line and configured to switch ON and OFF of a connection between the power supply and the row signal line and exclusively supply a drive current to the amplification transistor within each of the first to n^{th} pixels.

In accordance with a twentieth aspect of the present invention, there is provided a solid-state imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a second switching transistor having one of a source and a drain connected to a gate of the amplification transistor and the other of the source and the drain connected to a ground and configured to switch ON and OFF of a connection between the gate of the amplification transistor and the ground and exclusively supply a drive current to the amplification transistor within each of the first to n^{th} pixels.

In accordance with a twenty-first aspect of the present invention, there is provided a solid-state imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor connected to a column signal line arranged for each column connected to a current source for supplying a drive current and configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a third switching transistor having one of a source and a drain connected to the output terminal of the amplification transistor and the other of the source and the drain connected to the column signal line and configured to switch ON and OFF of a connection between the output terminal of the amplification transistor and the column signal line and exclusively supply the drive current to the amplification transistor within each of the first to n^{th} pixels.

In accordance with a twenty-second aspect of the present invention, there is provided an imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification circuit configured to output an amplified signal by amplifying a signal generated by the photoelectric conversion element, and a signal accumulation circuit arranged on the second substrate and configured to accumulate the amplified signal output from the amplification circuit; and a control unit configured to control a drive current to be exclusively supplied to the amplification circuit within each of the first to n^{th} pixels.

In accordance with a twenty-third aspect of the present invention, there is provided an imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a first switching transistor having one of a source and a drain connected to the output terminal of the amplification transistor and the other of the source and the drain connected to a ground, and configured to switch ON and OFF of a connection between the output terminal of the amplification transistor and the ground and exclusively supply a drive current to the amplification transistor within each of the first to n^{th} pixels.

In accordance with a twenty-fourth aspect of the present invention, there is provided an imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor connected to a row signal line arranged for each row and configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a changeover switch having one end connected to a power supply for supplying a voltage and the other end connected to the row signal line and configured to switch ON and OFF of a connection between the power supply and the row signal line and exclusively supply a drive current to the amplification transistor within each of the first to n^{th} pixels.

In accordance with a twenty-fifth aspect of the present invention, there is provided an imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a second switching transistor having one of a source and a drain connected to a gate of the amplification transistor and the other of the source and the drain connected to a ground and configured to switch ON and OFF of a connection between the gate of the amplification transistor and the ground and exclusively supply a drive current to the amplification transistor within each of the first to n^{th} pixels.

In accordance with a twenty-sixth aspect of the present invention, there is provided an imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion element arranged on the first substrate, an amplification transistor connected to a column signal line arranged for each column connected to a current source for supplying a drive current and configured to receive a signal generated by the photoelectric conversion element using a gate, amplify the signal received by the gate, and output the amplified signal from an output terminal, which is one of a source and a drain, and a memory circuit arranged on the second substrate and configured to accumulate the amplified signal output from the amplification transistor; and a third switching transistor having one of a source and a drain connected to the output terminal of the amplification transistor and the other of the source and the drain connected to the column signal line and configured to switch ON and OFF of a connection between the output terminal of the amplification transistor and the column signal line and exclusively supply the drive current to the amplification transistor within each of the first to n^{th} pixels.

In accordance with a twenty-seventh aspect of the present invention, there is provided a signal reading method of reading signals from pixels of a solid-state imaging device having electrically connected a first substrate and a second substrate on which circuit elements constituting the pixels are arranged, including the steps of: in each of a plurality of pixels classified as first to n^{th} (where n is an integer greater than or equal to 2) pixels, outputting an amplified signal by amplifying a signal generated from a photoelectric conversion element arranged on the first substrate using an amplification circuit; accumulating the amplified signal output from the amplification circuit in a signal accumulation circuit arranged on the second substrate; and outputting the amplified signal accumulated in the signal accumulation circuit from the pixel, wherein a drive current is controlled to be exclusively supplied to the amplification circuit within each of the first to n^{th} pixels.

### BRIEF DESCRIPTION OF THE DRAWINGS

FIG. 1 is a block diagram illustrating a configuration of an imaging device in accordance with a first embodiment of the present invention.

FIG. 2 is a block diagram illustrating a configuration of an imaging unit provided in an imaging device in accordance with the first embodiment of the present invention.

FIG. 3A is a cross-sectional view and a plan view of the imaging unit provided in the imaging device in accordance with the first embodiment of the present invention.

FIG. 3B is a cross-sectional view and a plan view of the imaging unit provided in the imaging device in accordance with the first embodiment of the present invention.

FIG. 4 is a circuit diagram illustrating a circuit configuration of a pixel provided in the imaging device in accordance with the first embodiment of the present invention.

FIG. 5 is a circuit diagram illustrating a circuit configuration of a pixel provided in the imaging device in accordance with the first embodiment of the present invention.

FIG. 6 is a timing chart illustrating an operation of the pixel provided in the imaging device in accordance with the first embodiment of the present invention.

FIG. 7 is a block diagram illustrating a configuration of an imaging unit provided in an imaging device in accordance with a second embodiment of the present invention.

FIG. 8 is a circuit diagram illustrating a circuit configuration of a pixel provided in the imaging device in accordance with the second embodiment of the present invention.

FIG. 9 is a circuit diagram illustrating a circuit configuration of a pixel provided in an imaging device in accordance with a third embodiment of the present invention.

FIG. 10 is a circuit diagram illustrating a circuit configuration of a pixel provided in an imaging device in accordance with a fourth embodiment of the present invention.

### DETAILED DESCRIPTION OF THE INVENTION

Hereinafter, embodiments of the present invention will be described with reference to the drawings. The following description includes specific details as examples. Of course, those skilled in the art would understand that even when various variations and changes are made or added to the specific details, they do not depart from the scope of the present invention. Accordingly, various embodiments as will be described hereinafter do not detract from the generality of the invention recited in the claims and do not limit the invention recited in the claims.

### First Embodiment

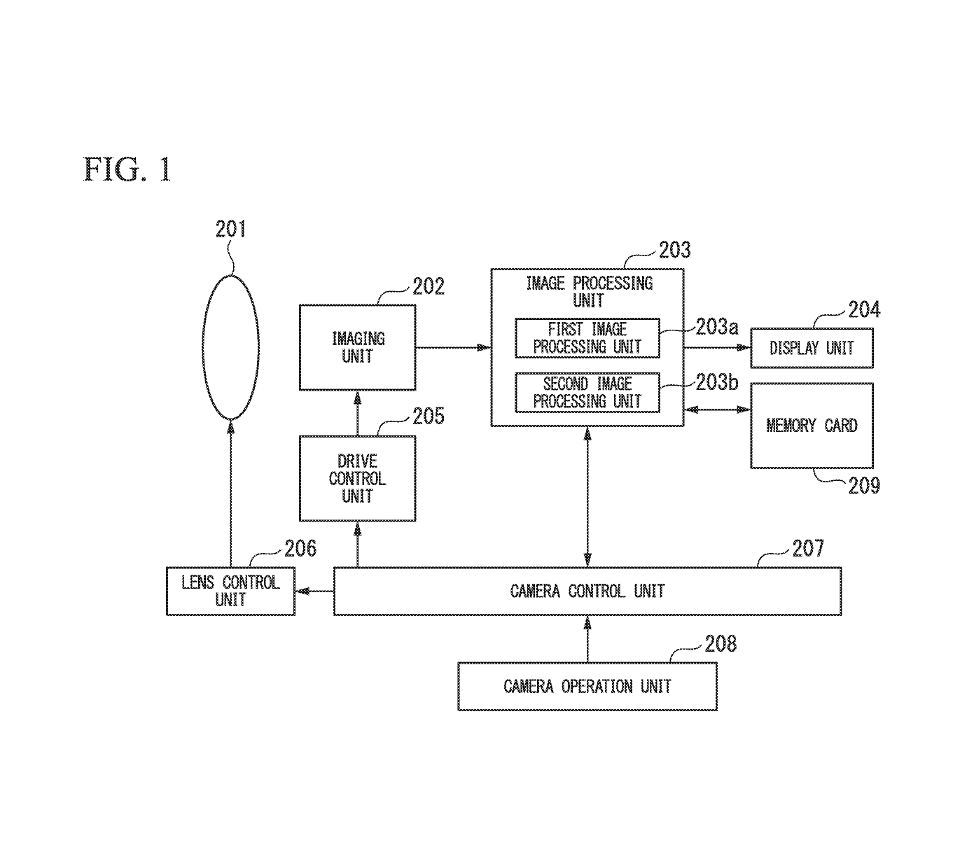

First, the first embodiment of the present invention will be described. FIG. 1 is a block diagram illustrating a configuration of an imaging device in accordance with this embodiment. It is only necessary that the imaging device in accordance with an aspect of the present invention be an electronic device having an imaging function. The imaging device in accordance with the aspect of the present invention may be a digital video camera, an endoscope, or the like as well as a digital camera.

The imaging device illustrated in FIG. 1 includes a lens 201, an imaging unit 202, an image processing unit 203, a display unit 204, a drive control unit 205, a lens control unit 206, a camera control unit 207, and a camera operation unit 208. Although a memory card 209 is also illustrated in FIG. 1, the memory card 209 may be configured to be detachable from the imaging device, and the memory card 209 is not necessarily a configuration integral to the imaging device.

Although blocks illustrated in FIG. 1 may be implemented by various components such as electrical circuit components such as a central processing unit (CPU) and a memory of a computer, an optical component such as a lens, and an operation component such as a button or a switch in hardware, or may be implemented by a computer program and the like in software, the blocks are described herein as being functional blocks implemented by combinations of the hardware and software. Accordingly, of course, those skilled in the art will understand that these functional blocks may be implemented in various forms by combinations of hardware and software.

The lens 201 is an imaging lens for forming an optical image of an object in an imaging area of the imaging unit 202 constituting a solid-state imaging device (solid-state imaging element). The imaging unit 202 converts the optical image of the object formed by the lens 201 into a digital image signal according to photoelectric conversion, and outputs the digital image signal. The image processing unit 203 performs various digital image processing operations on the image signal output from the imaging unit 202. The image processing unit 203 includes a first image processing unit 203a, which processes an image signal for recording, and a second image processing unit 203b, which processes an image signal for display.

The display unit 204 displays an image based on an image signal subjected to image processing for display by the second image processing unit 203b of the image processing unit 203. The display unit 204 may reproduce and display a still image and also perform moving image (live view) display in which an image of an imaged range is displayed in real time. The drive control unit 205 controls an operation of the imaging unit 202 based on an instruction from the camera control unit 207. The lens control unit 206 controls an aperture and/or a focal position of the lens 201 based on an instruction from the camera control unit 207.

The camera control unit 207 controls the entire imaging device. An operation of the camera control unit 207 is defined in a program stored in a read only memory (ROM) embedded in the imaging device. The camera control unit 207 reads the above-described program and performs various control operations according to content defined by the program. The camera operation unit 208 has various operation members for allowing a user to input various operations to the imaging device, and outputs a signal based on an operation input result to the camera control unit 207. Specific examples of the camera operation unit 208 include a power supply switch for turning on/off a power supply of the imaging device, a release button for a still-image capture instruction, a still-image capture mode switch for switching a still-image capture mode between a single shooting mode and a continuous shooting mode, and the like. The memory card 209 is a recording medium for storing an image signal processed by the first image processing unit 203a for recording.

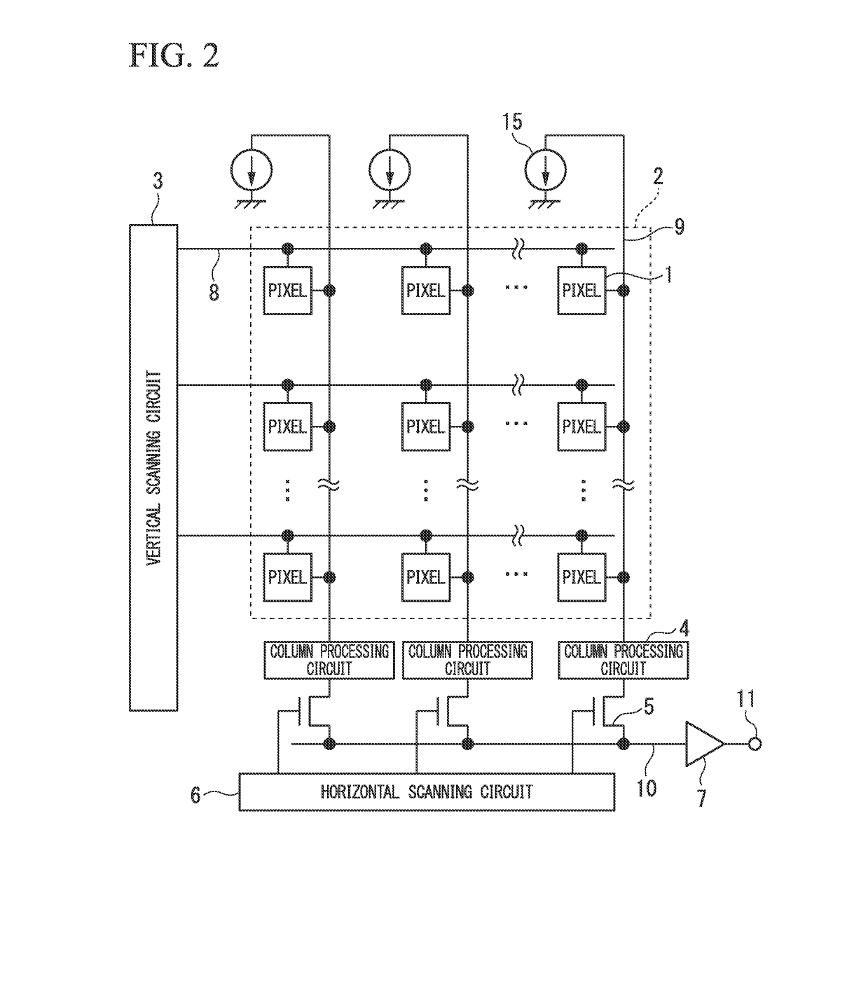

FIG. 2 illustrates a configuration of the imaging unit 202. The imaging unit 202 has a pixel unit 2 having a plurality of pixels 1, a vertical scanning circuit 3, column processing circuits 4, column selection transistors 5, a horizontal reading circuit 6, an output amplifier 7, and current sources 15. An arrangement position of each circuit element illustrated in FIG. 2 is not necessarily consistent with an actual arrangement position.

In the pixel unit 2, the plurality of pixels 1 are arranged in a 2D matrix. In FIG. 2, only some pixels 1 are illustrated. It is only necessary that each of the number of rows and the number of columns be greater than or equal to 2. Although an area including all the pixels provided in the imaging unit 202 is designated as an image-signal read target area in this embodiment, part of the area including all the pixels provided in the imaging unit 202 may be designated as the image-signal read target area. It is desirable that the read target area include all pixels of at least a valid pixel area. In addition, the read target area may include an optical black pixel (a pixel for which light is constantly shielded), which is arranged outside the valid pixel area. A pixel signal read from the optical black pixel is used, for example, for correction of a dark current component.

The vertical scanning circuit 3 is formed, for example, by a shift register, and controls driving of the pixels 1 in units of rows. The drive control includes an operation of resetting the pixels 1, an accumulation operation, a signal reading operation, or the like. To perform the drive control, the vertical scanning circuit 3 outputs a control signal (control pulse) to each pixel 1 via a control signal line 8 provided for each row, and independently controls the pixels 1 for each row. The vertical scanning circuit 3 performs the drive control, so that a pixel signal is output from the pixel 1 to the vertical signal line 9 provided for each column.

The column processing circuit 4 is connected to the vertical signal line 9 of each column and performs signal processing such as noise removal or amplification on a pixel signal output from the pixel 1. The column selection transistor 5 outputs the pixel signal processed by the column processing circuit 4 to a horizontal signal line 10. The horizontal reading circuit 6 controls ON and OFF of the column selection transistor 5.

The horizontal reading circuit 6 is formed, for example, by a shift register, and reads a pixel signal by selecting a pixel column from which the pixel signal is read, sequentially selecting and turning on the column selection transistor 5 related to the selected pixel column, and sequentially outputting the pixel signal processed by the column processing circuit 4 to the horizontal signal line 10. The output amplifier 7 performs signal processing on a pixel signal output to the horizontal signal line 10, and outputs the pixel signal to an outside via an output terminal 11. The current source 15 is connected to the vertical signal line 9 of each column, and functions as a load.

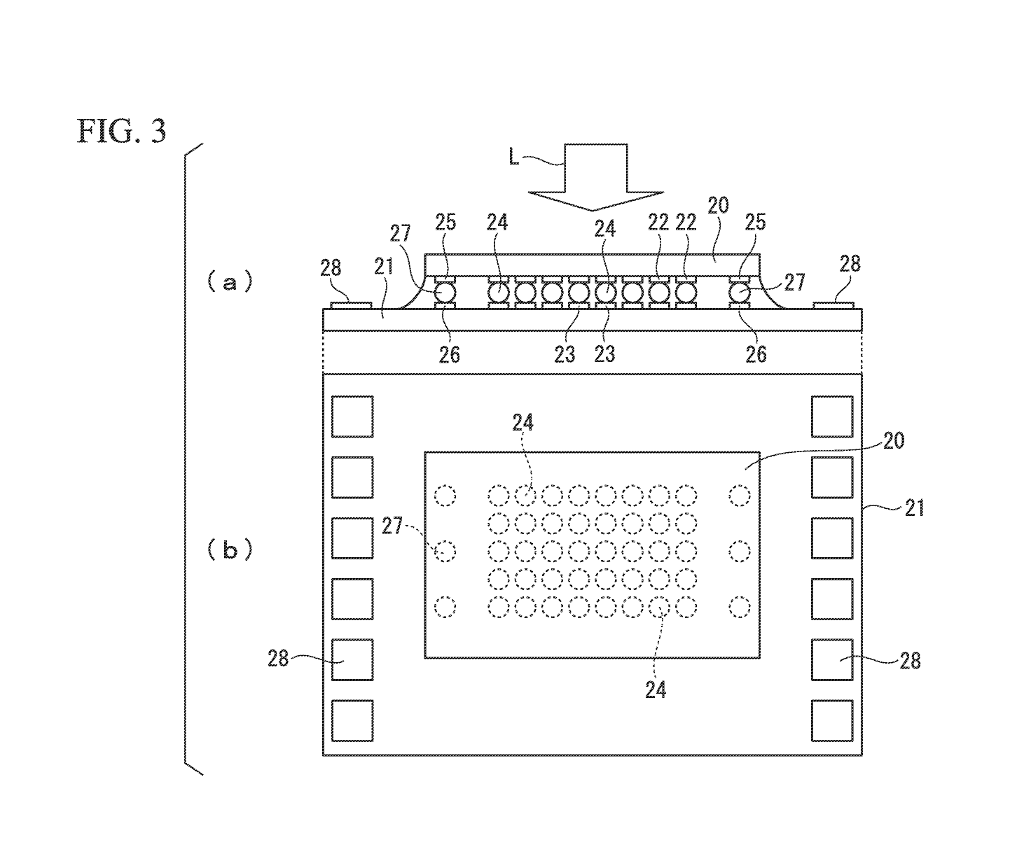

FIGS. 3A and 3B illustrate a cross-unital structure (FIG. 3A) and a planar structure (FIG. 3B) of the imaging unit 202. The imaging unit 202 has a structure with two overlapping substrates (a first substrate 20 and a second substrate 21) on which circuit elements (photoelectric conversion elements, transistors, capacitors, and the like) constituting the pixels 1 are arranged. The circuit elements constituting the pixels 1 are distributed and arranged on the first substrate 20 and the second substrate 21. The first substrate 20 and the second substrate 21 are electrically connected so that an electrical signal may be transmitted and received between the two substrates when the pixels 1 are driven.

Between two main surfaces (surfaces having relatively larger areas than side surfaces) of the first substrate 20, the photoelectric conversion element is formed on a main surface that is irradiated with light L, and light with which the first substrate 20 is irradiated is incident on the photoelectric conversion element. A large number of micro pads 22, which are electrodes for a connection to the second substrate 21, are formed on the main surface, which is opposite the main surface that is irradiated with the light L, between the two main surfaces of the first substrate 20. One micro pad 22 is arranged for each pixel or each plurality of pixels. In addition, a large number of micro pads 23, which are electrodes for a connection to the first substrate 20, are formed in positions corresponding to the micro pads 22 on the main surface, which faces the first substrate 20, between the two main surfaces of the second substrate 21.

Micro bumps 24 are formed between the micro pads 22 and the micro pads 23. The first substrate 20 and the second substrate 21 are integrated so that the micro pads 22 and the micro pads 23 are arranged to face and overlap each other and the micro bumps 24 are electrically connected between the micro pads 22 and the micro pads 23. The micro pads 22, the micro bumps 24, and the micro pads 23 constitute a connection unit that connects the first substrate 20 and the second substrate 21. A signal based on signal charges generated by the photoelectric conversion element arranged on the first substrate 20 is output to the second substrate 21 via the micro pad 22, the micro bump 24, and the micro pad 23.

Micro pads 25 having the same structures as the micro pads 22 are formed on peripheral portions of the main surface, which is opposite the main surface that is irradiated with the light L, between the two main surfaces of the first substrate 20. Micro pads 26 having the same structures as the micro pads 23 are formed in positions corresponding to the micro pads 25 on the main surface, which faces the first substrate 20, between the two main surfaces of the second substrates 21. Micro bumps 27 are formed between the micro pads 25 and the micro pads 26. A power supply voltage and the like for driving circuit elements arranged on the first substrate 20 or circuit elements arranged on the second substrate 21 are supplied from the first substrate 20 to the second substrate 21 or from the second substrate 21 to the first substrate 20 via the micro pads 25, the micro bumps 27, and the micro pads 26.

Pads 28 to be used as interfaces with a system other than the first substrate 20 and the second substrate 21 are formed on peripheral portions of one main surface of the two main surfaces of the second substrate 21. Instead of the pads 28, penetration electrodes penetrating the second substrate 21 may be provided and the penetration electrodes may be used as electrodes for external connections. Although areas of the main surfaces of the first substrate 20 and the second substrate 21 are different from each other in the example illustrated in FIG. 3, the areas of the main surfaces of the first substrate 20 and the second substrate 21 may be the same as each other. In addition, the first substrate 20 and the second substrate 21 may be connected by directly boding the micro pad (first electrode) provided on the surface of the first substrate 20 and the micro pad (second electrode) provided on the surface of the second substrate 21 without providing a micro bump.

The circuit elements constituting the pixels 1 are distributed and arranged on the first substrate 20 and the second substrate 21. In addition to the pixels, the vertical scanning circuit 3, the column processing circuits 4, the column selection transistors 5, the horizontal reading circuit 6, and the output amplifier 7 may each be arranged on either of the first substrate 20 and the second substrate 21.

In addition, circuit elements constituting the vertical scanning circuit 3, the column processing circuits 4, the column selection transistors 5, the horizontal reading circuit 6, and the output amplifier 7 may be distributed and arranged on the first substrate 20 and the second substrate 21. Although the transmission/reception of a signal between the first substrate 20 and the second substrate 21 is necessary even for elements other than the pixels 1, it is possible to connect the first substrate 20 and the second substrate 21 using the micro pads and the micro bumps as in the pixels 1 or connect the first substrate 20 and the second substrate 21 by establishing a direct connection between the micro pads.

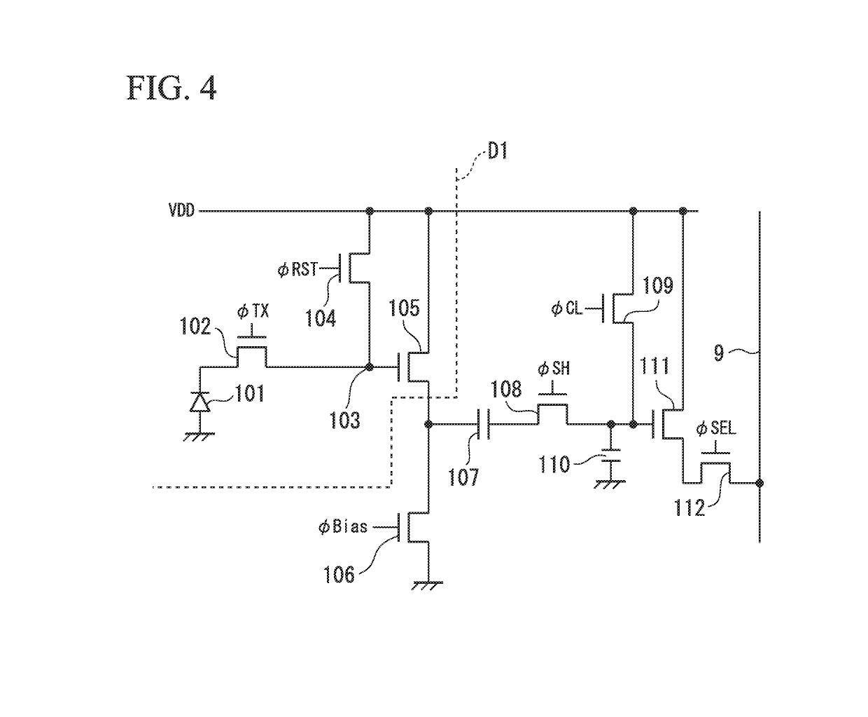

FIG. 4 illustrates a circuit configuration of the pixel 1. The pixel 1 has a photoelectric conversion element 101, a transfer transistor 102, a floating diffusion (FD) 103, an FD reset transistor 104, a first amplification transistor 105, a load transistor 106, a clamping capacitor 107, a sampling transistor 108, an analog memory reset transistor 109, an analog memory 110, a second amplification transistor 111, and a selection transistor 112. An arrangement position of each circuit element illustrated in FIG. 4 is not necessarily consistent with an actual arrangement position.

One end of the photoelectric conversion element 101 is connected to a ground. A drain terminal of the transfer transistor 102 is connected to the other end of the photoelectric conversion element 101. A gate terminal of the transfer transistor 102 is connected to the vertical scanning circuit 3, and supplied with a transfer pulse φTX. The FD 103 constitutes an input unit of the first amplification transistor 105, and is connected to a source terminal of the transfer transistor 102. The drain terminal of the FD reset transistor 104 is connected to a power supply voltage VDD, and the source terminal of the FD reset transistor 104 is connected to the source terminal of the transfer transistor 102. The gate terminal of the FD reset transistor 104 is connected to the vertical scanning circuit 3, and supplied with an FD reset pulse φRST.

The drain terminal of the first amplification transistor 105 is connected to the power supply voltage VDD. The gate terminal of the first amplification transistor 105 is connected to the source terminal of the transfer transistor 102. The drain terminal of the load transistor 106 is connected to the source terminal of the first amplification transistor 105, and the source terminal of the load transistor 106 is connected to the ground and grounded. The gate terminal of the load transistor 106 is connected to the vertical scanning circuit 3, and supplied with a current control pulse φBias.

One end of the clamping capacitor 107 is connected to the source terminal of the first amplification transistor 105 and the drain terminal of the load transistor 106. The drain terminal of the sampling transistor 108 is connected to the other end of the clamping capacitor 107. The gate terminal of the sampling transistor 108 is connected to the vertical scanning circuit 3, and supplied with a sampling pulse φSH.

The drain terminal of the analog memory reset transistor 109 is connected to the power supply voltage VDD, and the source terminal of the analog memory reset transistor 109 is connected to the source terminal of the sampling transistor 108. The gate terminal of the analog memory reset transistor 109 is connected to the vertical scanning circuit 3, and supplied with a clamping and memory reset pulse φCL.

One end of the analog memory 110 is connected to the source terminal of the sampling transistor 108, and the other end of the analog memory 110 is connected to the ground and grounded. The drain terminal of the second amplification transistor 111 is connected to the power supply voltage VDD. The gate terminal constituting an input unit of the second amplification transistor 111 is connected to the source terminal of the sampling transistor 108. The drain terminal of the selection transistor 112 is connected to the source terminal of the second amplification transistor 111, and the source terminal of the selection transistor 112 is connected to the vertical signal line 9. The gate terminal of the selection transistor 112 is connected to the vertical scanning circuit 3, and supplied with a selection pulse φSEL. In terms of each transistor described above, the polarity may be reversed and the source terminal and the drain terminal may be set in reverse to the above.

The photoelectric conversion element 101 is, for example, a photodiode, which generates signal charges based on incident light, and holds and accumulates the generated signal charges. The transfer transistor 102 is a transistor that transfers the signal charges accumulated in the photoelectric conversion element 101 to the FD 103. ON/OFF of the transfer transistor 102 is controlled by a transfer pulse φTX from the vertical scanning circuit 3. The FD 103 is a floating capacitor that temporarily holds and accumulates the signal charges transferred from the photoelectric conversion element 101.

The FD reset transistor 104 is a transistor that resets the FD 103. ON/OFF of the FD reset transistor 104 is controlled by the FD reset pulse φRST from the vertical scanning circuit 3. It is also possible to reset the photoelectric conversion element 101 by simultaneously turning on the FD reset transistor 104 and the transfer transistor 102. The reset of the FD 103/photoelectric conversion element 101 sets a state (potential) of the FD 103/photoelectric conversion element 101 to a standard state (a standard potential or a reset level) of the FD 103/photoelectric conversion element 101 by controlling an amount of charges accumulated in the FD 103/photoelectric conversion element 101.

The first amplification transistor 105 is a transistor that outputs an amplified signal, which is obtained by amplifying a signal based on the signal charges accumulated in the FD 103 input to the gate terminal that is the input unit, from the source terminal that is the output unit. The load transistor 106 is a transistor that functions as a load of the first amplification transistor 105, and supplies a current for driving the first amplification transistor 105 to the first amplification transistor 105. ON/OFF of the load transistor 106 is controlled by the current control pulse φBias from the vertical scanning circuit 3. The first amplification transistor 105 and the load transistor 106 constitute a source follower circuit.

The clamping capacitor 107 is a capacitor that clamps (fixes) a voltage level of the amplified signal output from the first amplification transistor 105. The sampling transistor 108 is a transistor that samples and holds a voltage level of the other end of the clamping capacitor 107 and accumulates the sampled and held voltage level in the analog memory 110. ON/OFF of the sampling transistor 108 is controlled by the sampling pulse φSH from the vertical scanning circuit 3.

The analog memory reset transistor 109 is a transistor that resets the analog memory 110. ON/OFF of the analog memory reset transistor 109 is controlled by a clamping and memory reset pulse φCL from the vertical scanning circuit 3. The reset of the analog memory 110 sets a state (potential) of the analog memory 110 to a standard state (a standard potential or a reset level) of the analog memory 110 by controlling an amount of charges accumulated in the analog memory 110. The analog memory 110 holds and accumulates an analog signal sampled and held by the sampling transistor 108.

A capacitor of the analog memory 110 is set to be greater than that of the FD 103. It is more desirable to use a metal-insulator-metal (MIM) capacitor or MOS capacitor, which are capacitors in which a leak current (dark current) per unit area is small, for the analog memory 110. Thereby, resistance to noise is improved and a high-quality signal is obtained.

The second amplification transistor 111 is a transistor that outputs an amplified signal, which is obtained by amplifying a signal based on the signal charges accumulated in the analog memory 110 input to the gate terminal, from the source terminal. The second amplification transistor 111 and the current source 15 serving as a load connected to the vertical signal line 9 constitute a source follower circuit. The selection transistor 112 is a transistor that selects a pixel 1 and transfers an output of the second amplification transistor 111 to the vertical signal line 9. ON/OFF of the selection transistor 112 is controlled by the selection pulse φSEL from the vertical scanning circuit 3.

Among the circuit elements illustrated in FIG. 4, the photoelectric conversion element 101 is arranged on the first substrate 20, the analog memory 110 is arranged on the second substrate 21, and each of the other circuit elements is arranged in one of the first substrate 20 and the second substrate 21. A dashed line D1 of FIG. 4 indicates a boundary line between the first substrate 20 and the second substrate 21. The photoelectric conversion element 101, the transfer transistor 102, the FD 103, the FD reset transistor 104, and the first amplification transistor 105 are arranged on the first substrate 20. The load transistor 106, the clamping capacitor 107, the sampling transistor 108, the analog memory reset transistor 109, the analog memory 110, the second amplification transistor 111, and the selection transistor 112 are arranged on the second substrate 21.

The amplified signal output from the first amplification transistor 105 of the first substrate 20 is output to the second substrate 21 via the micro pad 22, the micro bump 24, and the micro pad 23. In addition, the power supply voltage VDD is transmitted and received between the first substrate 20 and the second substrate 21 via the micro pad 25, the micro bump 27, and the micro pad 26.

Although a connection unit including the micro pad 22, the micro bump 24, and the micro pad 23 is arranged on a path among the source terminal of the first amplification transistor 105, the drain terminal of the load transistor 106, and the one end of the clamping capacitor 107 in FIG. 4, the present invention is not limited thereto. The connection unit may be arranged on a path electrically connected from the photoelectric conversion element 101 to the analog memory 110.

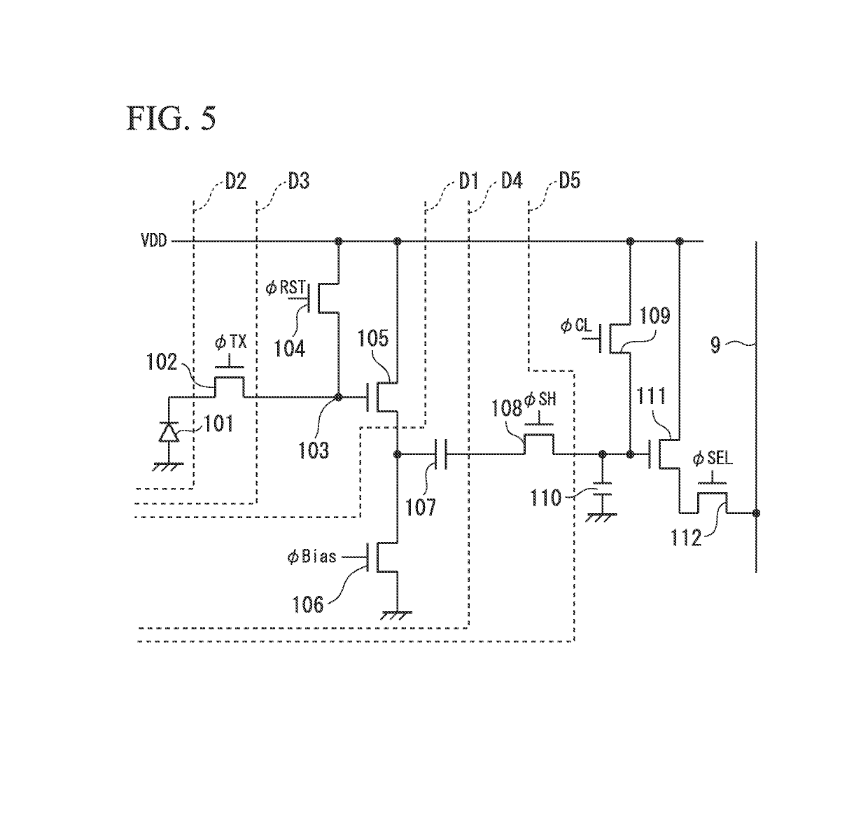

FIG. 5 illustrates examples of boundary lines between the first substrate 20 and the second substrate 21. Dashed lines D1 to D5 indicate possible examples of the boundary lines between the first substrate 20 and the second substrate 21. The boundary line between the first substrate 20 and the second substrate 21 may be one of the dashed line D1 to D5, or others. The dashed line D1 is the same as described above. In the example indicated by the dashed line D2, a connection unit is arranged on a path between the other end of the photoelectric conversion element 101 and the drain terminal of the transfer transistor 102. In the example indicated by the dashed line D3, a connection unit is arranged on a path among the source terminal of the transfer transistor 102, the source terminal of the FD reset transistor 104, and the gate terminal of the first amplification transistor 105.

In the example indicated by the dashed line D4, a connection unit is arranged on a path between the other end of the clamping capacitor 107 and the drain terminal of the sampling transistor 108. In the example indicated by the dashed line D5, a connection unit is arranged on a path among the source terminal of the sampling transistor 108, the source terminal of the analog memory reset transistor 109, the one end of the analog memory 110, and the gate terminal of the second amplification transistor 111.

All pixels 1 having the above-described configuration are classified into a plurality of groups, and each pixel 1 belongs to one of the plurality of groups. In this embodiment, the pixels 1 are classified into the plurality of groups according to pixel positions. In the example illustrated in FIG. 2, pixels 1 belonging to the same row constitute one group. That is, pixels 1 of a first row constitute a first group, pixels 1 of a second row constitute a second group, pixels 1 of a third row constitute a third group, . . . , pixels 1 of an n^{th} row (last row) constitute an n^{th} group.

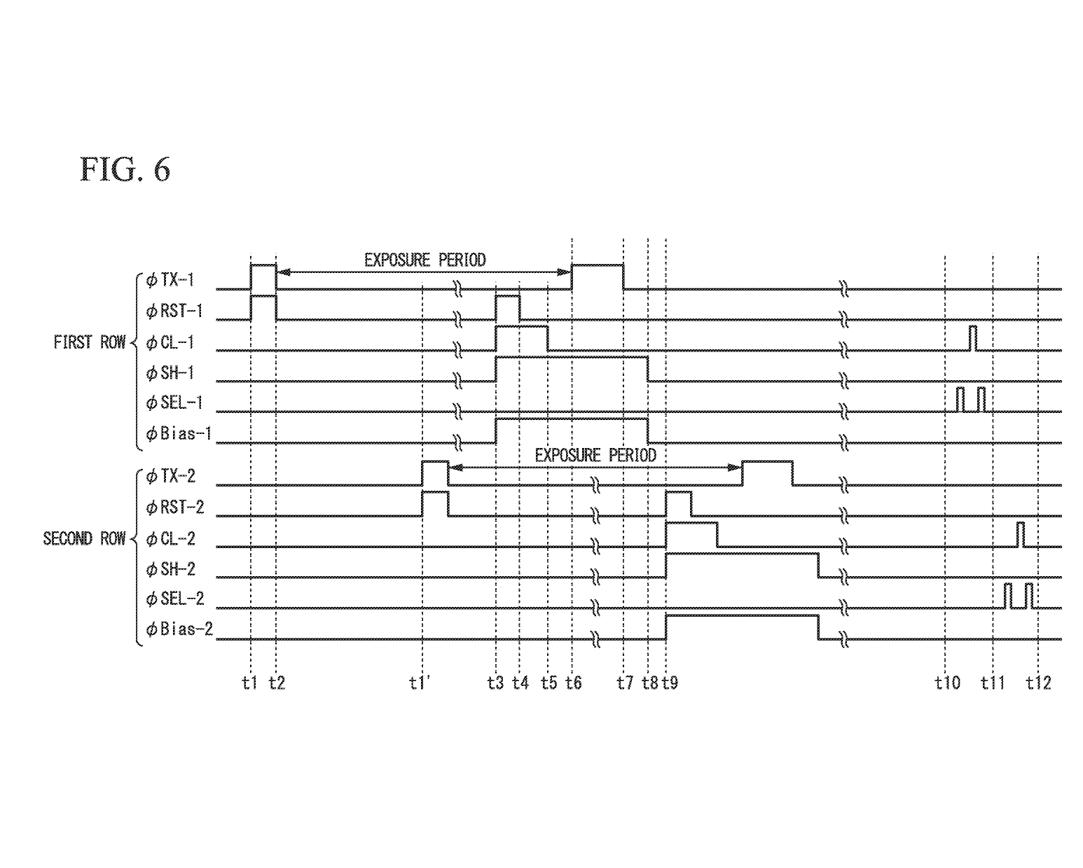

Next, an operation of the pixel 1 will be described with reference to FIG. 6. FIG. 6 illustrates control signals to be supplied from the vertical scanning circuit 3 to the pixels 1 for each row. Only control signals to be supplied to the pixels 1 of two rows in FIG. 6 are illustrated because of limitations of the space of the drawing, and control signals to be supplied to the pixels 1 of the remaining rows are omitted. Hereinafter, description will be given by adding a suffix indicating a row number to the control signal. For example, a transfer pulse φTX to be output to the pixel 1 of the first row is denoted by φTX-1.

At time t1, the transfer pulse φTX-1 output to the pixel 1 of the first row is varied from a “low (L)” level to a “high (H)” level, and hence the transfer transistor 102 of the pixel 1 of the first row is turned on. Simultaneously, an FD reset pulse φRST-1 output to the pixel 1 of the first row is varied from the “L” level to the “H” level, and hence the FD reset transistor 104 of the pixel 1 of the first row is turned on. Thereby, the photoelectric conversion element 101 is reset.

Subsequently, at time t2, the transfer pulse φTX-1 output to the pixel 1 of the first row and the FD reset pulse φRST-1 output to the pixel 1 of the first row are varied from the “H” level to the “L” level, and hence the transfer transistor 102 and the FD reset transistor 104 of the pixel 1 of the first row are turned off. Thereby, the reset of the photoelectric conversion element 101 ends and the exposure (signal charge accumulation) of the pixel 1 of the first row starts.

At time t3 within an exposure period, the FD reset pulse φRST-1 output to the pixel 1 of the first row is varied from the “L” level to the “H” level, and hence the FD reset transistor 104 of the pixel 1 of the first row is turned on. Thereby, the FD 103 is reset. Simultaneously, a current control pulse φBias-1 output to the pixel 1 of the first row is varied from the “L” level to the “H” level, and hence the load transistor 106 of the pixel 1 of the first row is turned on. Thereby, a drive current is supplied to the first amplification transistor 105, and an amplification operation of the first amplification transistor 105 starts.

Simultaneously, a clamping and memory reset pulse φCL-1 output to the pixel 1 of the first row is varied from the “L” level to the “H” level, and hence the analog memory reset transistor 109 of the pixel 1 of the first row is turned on. Thereby, the analog memory 110 is reset. Simultaneously, a sampling pulse φSH-1 output to the pixel 1 of the first row is varied from the “L” level to the “H” level, and hence the sampling transistor 108 of the pixel 1 of the first row is turned on. Thereby, a potential of the other end of the clamping capacitor 107 is reset to the power supply voltage VDD, and the sampling transistor 108 also starts the sampling and holding of the potential of the other end of the clamping capacitor 107.

Subsequently, at time t4 within the exposure period, the FD reset pulse φRST-1 output to the pixel 1 of the first row is varied from the “H” level to the “L” level, and hence the FD reset transistor 104 of the pixel 1 of the first row is turned off. Thereby, the reset of the FD 103 of the pixel 1 of the first row ends.

Although it is only necessary that the timing of the reset of the FD 103 be in the exposure period, it is possible to further reduce noise by a leak current of the FD 103 by resetting the FD 103 at the timing immediately before the end of the exposure period.

Subsequently, at time t5 within the exposure period, the clamping and memory reset pulse φCL-1 output to the pixel 1 of the first row is varied from the “H” level to the “L” level, and hence the analog memory reset transistor 109 of the pixel 1 of the first row is turned off. Thereby, the reset of the analog memory 110 of the pixel 1 of the first row ends. At this time, the clamping capacitor 107 clamps the amplified signal (the amplified signal after the reset of the FD 103) output from the first amplification transistor 105.

Subsequently, at time t6, the transfer pulse φTX-1 output to the pixel 1 of the first row is varied from the “L” level to the “H” level, and hence the transfer transistor 102 of the pixel 1 of the first row is turned on.

Thereby, the signal charges accumulated in the photoelectric conversion element 101 of the pixel 1 of the first row are transferred to the FD 103 via the transfer transistor 102 and accumulated in the FD 103. Thereby, the exposure (signal charge accumulation) of the pixel 1 of the first row ends. As illustrated in FIG. 6, a period from time t2 to time t6 is an exposure period (signal accumulation period). Subsequently, at time t7, the transfer pulse φTX-1 output to the pixel 1 of the first row is varied from the “H” level to the “L” level, and hence the transfer transistor 102 of the pixel 1 of the first row is turned off.

Subsequently, at time t8, the sampling pulse φSH-1 output to the pixel 1 of the first row is varied from the “H” level to the “L” level, and hence the sampling transistor 108 of the pixel 1 of the first row is turned off. Thereby, the sampling transistor 108 ends the sampling and holding of the potential of the other end of the clamping capacitor 107. Simultaneously, the current control pulse φBias-1 output to the pixel 1 of the first row is varied from the “H” level to the “L” level, and hence the load transistor 106 of the pixel 1 of the first row is turned off. Thereby, the supply of a drive current to the first amplification transistor 105 is stopped, and the amplification operation of the first amplification transistor 105 is stopped.

When a change in a potential of the one end of the FD 103 according to the transfer of the signal charges from the photoelectric conversion element 101 to the FD 103 after the reset of the FD 103 ends is ΔVfd and a gain of the first amplification transistor 105 is α1, a change ΔVamp1 in a potential of the source terminal of the first amplification transistor 105 according to the transfer of the signal charges from the photoelectric conversion element 101 to the FD 103 is α1×ΔVfd.

When a gain of a sum of the analog memory 110 and the sampling transistor 108 is α2, a change ΔVmem in a potential of the one end of the analog memory 110 according to the sampling and holding of the sampling transistor 108 after the transfer of the signal charges from the photoelectric conversion element 101 to the FD 103 becomes α2×ΔVamp1, that is, α1×α2×ΔVfd. Because the potential of the one end of the analog memory 110 is the power supply voltage VDD at the timing at which the reset of the analog memory 110 has ended, the potential Vmem of the one of the analog memory 110 sampled and held by the sampling transistor 108 after the transfer of the signal charges from the photoelectric conversion element 101 to the FD 103 becomes the following Expression (1). In Expression (1), ΔVmem<0 and ΔVfd<0.

$$\begin{matrix}Vmem = VDD + Δ Vmem \\ = VDD + α 1 \times α 2 \times Δ Vfd\end{matrix} \qquad ( 1 )$$

In addition, α2 becomes the following Expression (2). In Expression (2), CL is a capacitance value of the clamping capacitor 107, and CSH is a capacitance value of the analog memory 110. It is more desirable that the capacitance value CL of the clamping capacitor 107 be greater than the capacitance value CSH of the analog memory 110 so as to further reduce the degradation of the gain.

$$α 2 = \frac{CL}{CL + CSH} \qquad ( 2 )$$

An operation that is substantially the same as the operation of the pixel 1 of the first row at times t1 to t8 described above is sequentially performed for each row.

As illustrated in FIG. 6, at time t1′ after time t2, an operation of the pixel 1 of the second row starts. The load transistor 106 of the pixel 1 of the second row is turned on at time t9 after time t8 at which the load transistor 106 of the pixel 1 of the first row is turned off so that the load transistor 106 of the pixel 1 of the first row and the load transistor 106 of the pixel 1 of the second row are not simultaneously turned on. Exposure periods of the rows are the same. Until amplified signals are transferred to analog memories 110 in pixels 1 of all rows, that is, all pixels, an operation that is substantially the same as the above-described operation is sequentially performed for each row.

At time t10 or later at which the above-described operation has ended in all the pixels, a signal based on the signal charges accumulated in the analog memory 110 is sequentially read for each row. In a period of times t10 to t11, a signal is read from the pixel 1 of the first row. First, a selection pulse φSEL-1 output to the pixel 1 of the first row is varied from the “L” level to the “H” level, and hence the selection transistor 112 of the pixel 1 of the first row is turned on. Thereby, a signal based on the potential Vmem shown in Expression (1) is output to the vertical signal line 9 via the selection transistor 112. Subsequently, the selection pulse φSEL-1 output to the pixel 1 of the first row is varied from the “H” level to the “L” level, and hence the selection transistor 112 of the pixel 1 of the first row is turned off.

Subsequently, the clamping and memory reset pulse φCL-1 output to the pixel 1 of the first row is varied from the “L” level to the “H” level, and hence the analog memory reset transistor 109 of the pixel 1 of the first row is turned on. Thereby, the analog memory 110 of the first row is reset. Subsequently, the clamping and memory reset pulse φCL-1 output to the pixel 1 of the first row is varied from the “H” level to the “L” level, and hence the analog memory reset transistor 109 of the pixel 1 of the first row is turned off.

Subsequently, the sampling pulse φSH-1 output to the pixel 1 of the first row is varied from the “L” level to the “H” level, and hence the selection transistor 112 of the pixel 1 of the first row is turned on. Thereby, a signal based on a potential of the one end of the analog memory 110 when the analog memory 110 has been reset is output to the vertical signal line 9 via the selection transistor 112. Subsequently, the selection pulse φSEL-1 is varied from the “H” level to the “L” level, and hence the selection transistor 112 is turned off.

The column processing circuit 4 generates a difference signal having a difference between the signal based on the potential Vmem shown in Expression (1) and the signal based on the potential of the one end of the analog memory 110 when the analog memory 110 has been reset. This difference signal is a signal based on a difference between the potential Vmem shown in Expression (1) and the power supply voltage VDD, and is a signal based on a difference ΔVfd between the potential of the one end of the FD 103 immediately after the signal charges accumulated in the photoelectric conversion element 101 have been transferred to the FD 103 and the potential of the FD 103 immediately after the one end of the FD 103 has been reset. Thereby, it is possible to obtain a signal component based on the signal charges accumulated in the photoelectric conversion element 101 suppressing a noise component according to the reset of the analog memory 110 and a noise component according to the reset of the FD 103.

A signal output from the column processing circuit 4 is output to the horizontal signal line 10 via the column selection transistor 5. The output amplifier 7 processes the signal output to the horizontal signal line 10 and outputs the processed signal as a pixel signal from the output terminal 11. Then, the reading of the signal from the pixel 1 of the first row ends.

In a period of times t11 to t12, a signal is read from the pixel 1 of the second row. Because an operation of reading the signal from the pixel 1 of the second row is substantially the same as the operation of reading the signal from the pixel 1 of the first row, description thereof is omitted here. Similar operations are performed for every row for pixels 1 of third and subsequent rows. After an operation of reading signals from all pixels has ended, the operation may be performed again from time t1 or the operation related to the pixel 1 may end.

In the global shutter operation of collectively performing exposures of photoelectric conversion elements in all pixels, FD should hold signal charges transferred from the photoelectric conversion element to the FD collectively in all the pixels until reading timings of the pixels are reached. In addition, in the operation of the pixel 1 illustrated in FIG. 6, the signal charges transferred from the photoelectric conversion element 101 to the FD 103 should be held by the FD 103 sequentially for each row until the reading timing of each pixel 1 is reached. If noise occurs during a period in which the FD 103 holds the signal charges, noise is superimposed on the signal charges held by the FD 103 and signal quality (signal to noise (S/N)) is degraded.

The major cause of noise occurring during a period (hereinafter referred to as a holding period) in which the FD 103 holds the signal charges is charges (hereinafter referred to as leak charges) by a leak current of the FD 103 and charges (hereinafter referred to as optical charges) due to light incident on a portion other than the photoelectric conversion element 101. When an amount of leak charges and an amount of optical charges occurring in a unit time are qid and qpn, respectively, and a length of the holding period is tc, an amount of noise charges Qn occurring during the holding period becomes (qid+qpn)tc.

It is assumed that capacitance of the FD 103 is Cfd, capacitance of the analog memory 110 is Cmem, and a ratio between Cfd and Cmem (Cmem/Cfd) is A. In addition, as described above, it is assumed that the gain of the first amplification transistor 105 is α1 and the gain of the sum of the analog memory 110 and the sampling transistor 108 is α2. When an amount of signal charges generated by the photoelectric conversion element 101 during the exposure period is Qph, an amount of signal charges held in the analog memory 110 after the end of the exposure period is A×α1×α2×Qph.

A signal based on signal charges transferred from the photoelectric conversion element 101 to the FD 103 is sampled and held by the sampling transistor 108 until time t8 is reached, and stored in the analog memory 110. Accordingly, a time until the signal charges are stored in the analog memory 110 after the signal charges are transmitted to the FD 103 is short, and noise occurring in the FD 103 may be neglected. Assuming that noise occurring during a period in which the analog memory 110 holds the signal charges is Qn as described above, the S/N becomes A×α1×α2×Qph/Qn.

On the other hand, when signal charges held in a capacitance accumulation unit are read from a pixel via the amplification transistor, the S/N becomes Qph/Qn. Accordingly, the S/N of this embodiment is A×α1×α2 times greater than the S/N of the related art. It is possible to reduce the degradation of signal quality by setting a capacitance value of the analog memory 110 so that a value of A×α1×α2 is greater than 1 (for example, by setting the capacitance value of the analog memory 110 sufficiently larger than a capacitance value of the FD 103).

In the above-described operation, in a first period (a period of times t3 to t6, which is part of the exposure period) in which the photoelectric conversion element 101 generates signal charges after the reset has been performed and a second period (a period of times t6 to t8) in which the signal charges accumulated in the photoelectric conversion element 101 are transferred to the FD 103, the analog memory 110 accumulates an amplified signal corresponding to signal charges transferred to the FD 103, the load transistor 106 is turned on and a drive current is supplied to the first amplification transistor 105. In addition, in a period including a third period (a period of time t9 or later) in which a signal is output from the pixel 1 among periods other than the first period and the second period, the load transistor 106 is turned off and the supply of the drive current to the first amplification transistor 105 is stopped.

The pixel 1 of this embodiment has a function of controlling ON and OFF of the load transistor 106 (controlling ON and OFF of the drive current to the first amplification transistor 105) independently for each row according to the current control pulse φBias from the vertical scanning circuit 3. In addition, only the load transistors 106 of the pixels 1 of some rows are turned on at the same time so that the load transistors 106 of the pixels 1 of all rows, that is, all pixels, are not simultaneously turned on. Control is performed to exclusively turn on the load transistors 106 so that the load transistors 106 of the pixels 1 of the remaining rows excluding some rows are turned on.

More specifically, as illustrated in FIG. 6, control is performed to exclusively turn on the load transistors 106 for each row, and only the load transistors 106 of the pixels 1 of one row are turned on at the same time.

Although it is possible to control the load transistors 106 of all the pixels to be simultaneously turned on until amplified signals in all the pixels are accumulated in the analog memories 110 after the reset of the photoelectric conversion element 101 of the pixel 1 of the first row starts, current consumption (a peak current) is increased when such control has been performed. In this embodiment, it is possible to suppress an increase in current consumption (a peak current) and reduce the occurrence of a decrease in a power supply voltage, an increase in a ground voltage, or the like by turning on only the load transistors 106 of the pixels 1 of some rows at the same time as described above.

In the rolling shutter scheme of the related art, for each row, an operation (transfer operation) of transferring signal charges generated by the photoelectric conversion element to the FD is performed, and subsequently an operation (horizontal operation) of reading a signal based on signal charges accumulated in the FD from the pixel to the vertical signal line is performed. More specifically, after the transfer operation and the horizontal operation of the first row have been performed, the transfer operation and the horizontal operation of the second row are performed. Similar operations are sequentially performed for each row thereafter. In the rolling shutter scheme of the related art, as described above, because the timing of exposure is different for each row, the object within a captured image may be distorted when the object of fast motion is imaged.

On the other hand, in this embodiment, for each row, an operation (transfer operation) of transferring signal charges generated by the photoelectric conversion element 101 to the FD 103 is performed, and subsequently an operation (accumulation operation) of accumulating an amplified signal based on signal charges transferred to the FD 103 in the analog memory 110 is performed. More specifically, after the transfer operation and the accumulation operation of the first row have been performed, the transfer operation and the accumulation operation of the second row are performed. Similar operations are sequentially performed for each row thereafter. When the transfer operation and the accumulation operation end in all pixels, an operation (horizontal operation) of reading a pixel signal based on signal charges accumulated in the analog memory 110 from the pixel 1 to the horizontal signal line 10 is performed.

Although not illustrated in FIG. 6 due to limitations of the space of the drawing, a period of time in which pixel signals of one row are read is longer than a period (a period of times t10 to t11) illustrated in FIG. 6 because an operation of sequentially reading pixel signals to the horizontal signal line 10 for each column in the horizontal operation is performed. In this embodiment, because a transfer operation and an accumulation operation are performed for each row, and the horizontal operation is performed after the transfer and accumulation operations of all the pixels have ended, a time necessary for the transfer operation and the accumulation operation for all the pixels is shorter than a time necessary for the transfer operation and the horizontal operation in the rolling shutter scheme of the related art. Accordingly, it is possible to reduce distortion of an object within a captured image.

As described above, in accordance with this embodiment, it is possible to suppress an increase in a chip area (it is easy to arrange an increasing number of pixels) by arranging circuit elements constituting pixels on the two substrates and accumulating an amplified signal output from the amplification circuit (the first amplification transistor 105) in a signal accumulation circuit (the analog memory 110) without converting the amplified signal into a digital signal. Further, it is possible to reduce the degradation of signal quality by providing the signal accumulation circuit (the analog memory 110). Further, it is possible to suppress an increase in current consumption by controlling the exclusive supply of a drive current to the amplification circuit (the first amplification transistor 105).

In addition, because it is possible to increase an area of photoelectric conversion elements of the first substrate as compared to when circuit elements of all pixels are arranged on one substrate, sensitivity is improved. Further, it is possible to reduce an area of a region for signal accumulation provided in the second substrate using the analog memory.

In addition, a capacitance value of the analog memory 110 is greater than a capacitance value of the FD 103 (for example, the capacitance value of the analog memory 110 is five times greater than the capacitance value of the FD 103), and hence an amount of signal charges held by the analog memory 110 is greater than an amount of signal charges held by the FD 103. Thus, it is possible to reduce the influence of signal degradation by a leak current of the analog memory 110.

In addition, it is possible to reduce noise occurring in the first substrate 20 by providing the clamping capacitor 107 and the sampling transistor 108. The noise occurring in the first substrate 20 is noise (for example, reset noise) occurring in the input unit of the first amplification transistor 105 due to an operation of a circuit (for example, the FD reset transistor 104) connected to the first amplification transistor 105, noise resulting from operation characteristics of the first amplification transistor 105 (for example, noise due to a variation in a circuit threshold value of the first amplification transistor 105), or the like.

In addition, a signal when the analog memory 110 has been reset and a signal corresponding to a change in an output of the first amplification transistor 105 caused by transferring signal charges from the photoelectric conversion element 101 to the FD 103 are output from the pixel 1 in time division and difference processing of each signal outside the pixel 1 is performed, and hence noise occurring in the second substrate 21 may be reduced. Noise occurring in the second substrate 21 is noise (for example, reset noise) occurring in the input unit of the second amplification transistor 111 resulting from an operation of a circuit (for example, the analog memory reset transistor 109) connected to the second amplification transistor 111.

### Second Embodiment

Next, the second embodiment of the present invention will be described. In this embodiment, the configuration of the imaging unit 202 is different from that of the first embodiment. Hereinafter, the configuration of the imaging unit 202 will be described. Because other configurations are substantially the same as in the first embodiment, description thereof is omitted here.

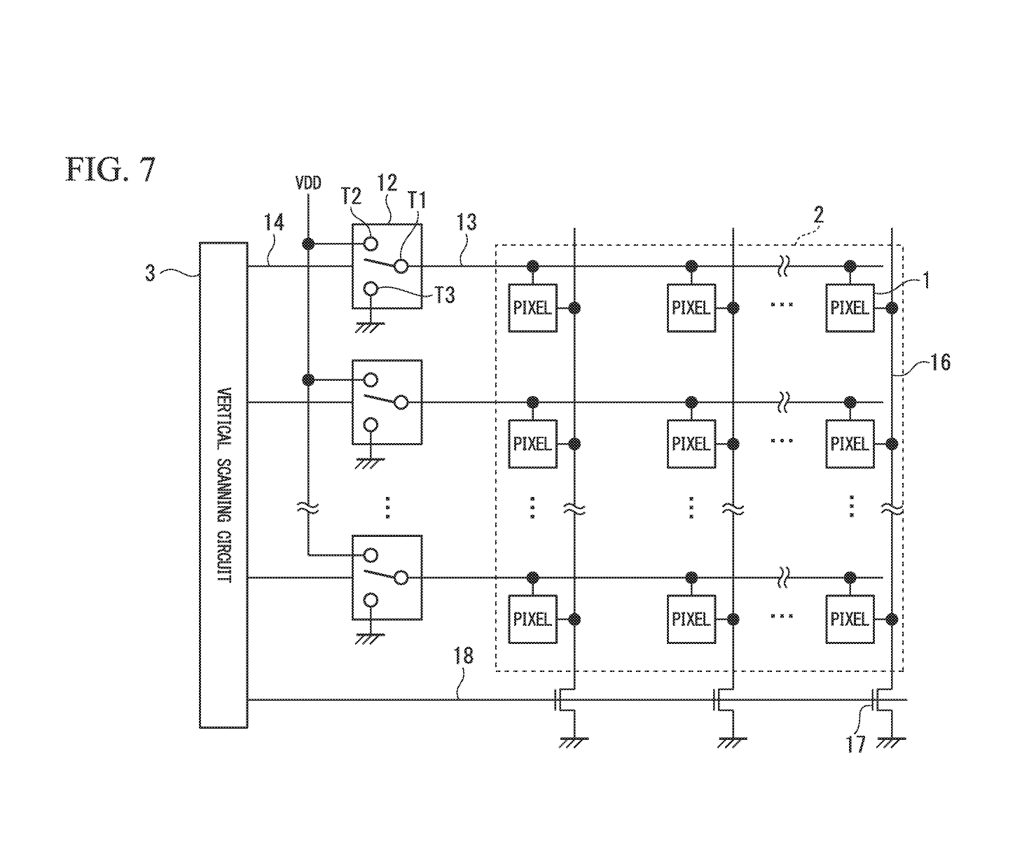

FIG. 7 illustrates a configuration of part of the imaging unit 202 of this embodiment. In FIG. 7, the illustration of the column processing circuits 4, the column selection transistors 5, the horizontal reading circuit 6, the output amplifier 7, the control signal line 8, the vertical signal line 9, the horizontal signal line 10, and the output terminal 11 is omitted. A power supply line 13 is provided for each row, and the power supply line 13 of each row supplies the power supply voltage VDD to the pixel 1 of each row. In addition, a changeover switch 12 is provided in correspondence with each row. The changeover switch 12 of each row switches ON and OFF of a connection between the power supply for supplying the power supply voltage VDD and the power supply line 13.

The changeover switch 12 has terminals T1, T2, and T3. The terminal T1 is connected to the power supply line 13, the terminal T2 is connected to the power supply, and the terminal T3 is connected to the ground and grounded. When a connection between the power supply and the power supply line 13 is turned on, the changeover switch 12 connects the terminal T1 to the terminal T2. In addition, when the connection between the power supply and the power supply line 13 is turned off, the changeover switch 12 connects the terminals T1 and T3. The changeover switch 12 is connected to a vertical scanning circuit 3 via a power supply control line 14 provided for each row. An operation of the changeover switch 12 is controlled by a switch control pulse φSW supplied from the vertical scanning circuit 3 via the power supply control line 14.

In addition, a current control line 16 is provided for each column, and a current source 17 serving as a load is connected to the current control line 16 of each column. The current source 17 is connected to the vertical scanning circuit 3 via a control signal line 18. ON and OFF of the current source 17 are controlled by a control pulse supplied from the vertical scanning circuit 3 via the control signal line 18. Because configurations other than the above are substantially the same as those illustrated in FIG. 2, description thereof is omitted here.

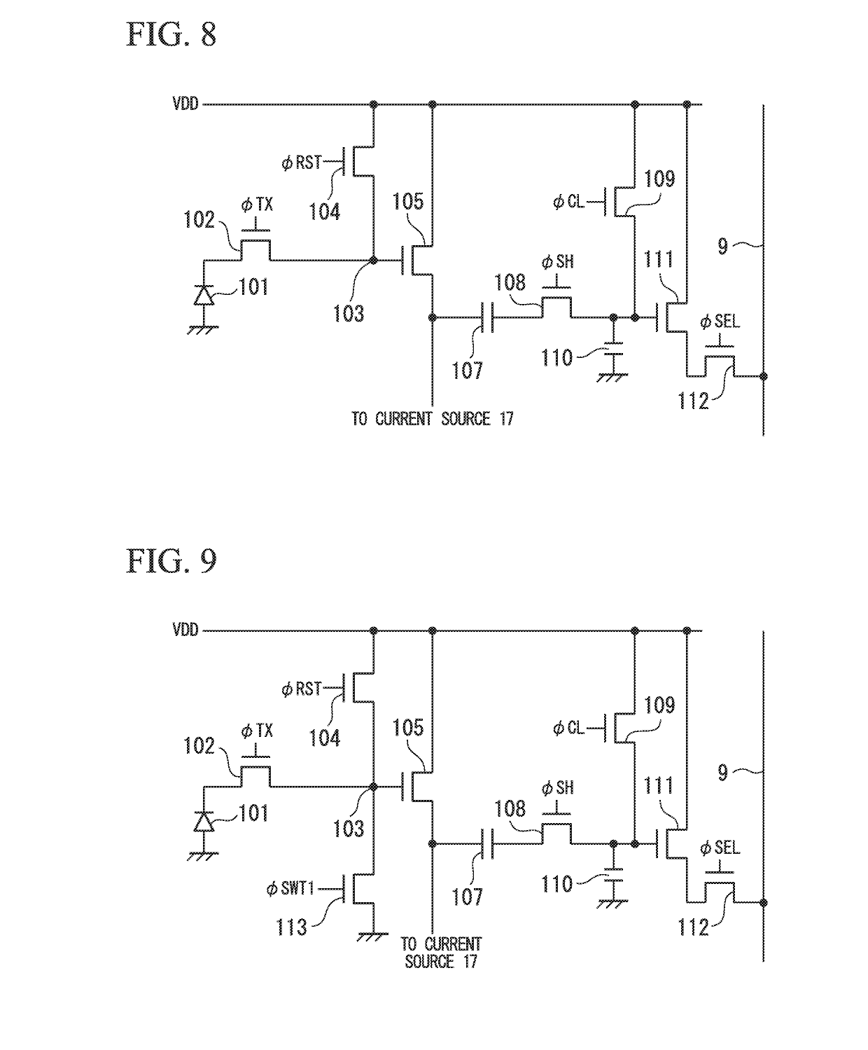

FIG. 8 illustrates a circuit configuration of the pixel 1 of this embodiment. As compared with the configuration illustrated in FIG. 4, the load transistor 106 is not provided in FIG. 8, and the source terminal of the first amplification transistor 105 is connected to one end of the clamping capacitor 107, connected to the current source 17 of FIG. 7, and grounded via the current source 17. Because the other configurations are substantially the same as those illustrated in FIG. 4, description thereof is omitted here.

The majority of the operation of the pixel 1 in this embodiment is substantially the same as the operation illustrated in FIG. 6. A difference from the operation illustrated in FIG. 6 is that the switch control pulse φSW is supplied to the changeover switch 12 of each row instead of the current control pulse φBias of FIG. 6. The switch control pulse φSW is at the “H” level in a period in which the current control pulse φBias of FIG. 6 is at the “H” level, and the switch control pulse φSW is at the “L” level in a period in which the current control pulse φBias is at the “L” level.

When the switch control pulse φSW is at the “H” level, the changeover switch 12 connects the terminal T1 and the terminal T2. Thereby, the power supply voltage VDD is supplied to the drain terminal of the first amplification transistor 105, and the drive current is supplied to the first amplification transistor 105. In addition, when the switch control pulse φSW is at the “L” level, the changeover switch 12 connects the terminal T1 and the terminal T3. Thereby, a ground level is supplied to the drain terminal of the first amplification transistor 105, and the supply of the drive current to the first amplification transistor 105 is stopped.

A control pulse supplied from the vertical scanning circuit 3 to the current source 17 via the control signal line 18 is at the “H” level when the switch control pulse φSW of any one row is at the “H” level, and is at the “L” level when switch control pulses φSW of all rows are at the “L” level. That is, the current source 17 is turned on when the drive current is supplied to the first amplification transistor 105 of any one row.

In accordance with this embodiment, it is possible to control the drive current to be exclusively supplied to the first amplification transistor 105 by controlling ON and OFF of a connection between the power supply and the power supply line 13 according to the changeover switch 12. Accordingly, it is possible to suppress an increase in current consumption. Although it is possible to suppress the increase in the current consumption even when the current source 17 is turned on in all periods in which the operation related to the pixel 1 is performed without controlling ON and OFF of the current source 17 according to a variation in the switch control pulse φSW, the certainty of the operation is further increased by controlling ON and OFF of the current source 17 as described above.

### Third Embodiment

Next, the third embodiment of the present invention will be described. In this embodiment, the configuration of the pixel 1 is different from that of the first embodiment. Hereinafter, the configurations of the imaging unit 202 and the pixel 1 will be described. Because the other configurations are substantially the same as those of the first embodiment, description thereof is omitted here. Because the configuration of the imaging unit 202 is substantially the same as in the second embodiment, description thereof is omitted here.

FIG. 9 illustrates a circuit configuration of the pixel 1 of this embodiment. As compared to the configuration illustrated in FIG. 4, the load transistor 106 is not provided in FIG. 9, and the source terminal of the first amplification transistor 105 is connected to one end of the clamping capacitor 107, connected to the current source 17 of FIG. 7, and grounded via the current source 17. In addition, a switching transistor 113 is provided.

The drain terminal of the switching transistor 113 is connected to the FD 103, and the source terminal of the switching transistor 113 is connected to the ground and grounded. The gate terminal of the switching transistor 113 is connected to the vertical scanning circuit 3, and supplied with a switching pulse φSWT1. The switching transistor 113 is a transistor that switches ON and OFF of a connection between the gate terminal of the first amplification transistor 105 and the ground. ON and OFF of the switching transistor 113 are controlled according to the switching pulse φSWT1 from the vertical scanning circuit 3. Because configurations other than the above are substantially the same as those illustrated in FIG. 4, description thereof is omitted here.

The majority of the operation of the pixel 1 in this embodiment is substantially the same as the operation illustrated in FIG. 6. A difference from the operation illustrated in FIG. 6 is that the switching pulse φSWT1 is supplied to the pixel 1 instead of the current control pulse φBias of FIG. 6. The switching pulse φSWT1 is at the “L” level during a period in which the current control pulse φBias of FIG. 6 is at the “H” level, and the switching pulse φSWT1 is at the “H” level during a period in which the current control pulse φBias is at the “L” level.

When the switching pulse φSWT1 is at the “L” level, the switching transistor 113 is turned off. Thereby, a connection between the gate terminal of the first amplification transistor 105 and the ground is turned off, and the drive current is supplied to the first amplification transistor 105. In addition, when the switching pulse φSWT1 is at the “H” level, the switching transistor 113 is turned on. Thereby, the connection between the gate terminal of the first amplification transistor 105 and the ground is turned on, and the supply of the drive current to the first amplification transistor 105 is stopped.

The control pulse supplied from the vertical scanning circuit 3 to the current source 17 via the control signal line 18 is at the “H” level when the switching pulse φSWT1 of any one row is at the “L” level, and is at the “L” level when switching pulses φSWT1 of all rows are at the “H” level. That is, the current source 17 is turned on when the drive current is supplied to the first amplification transistor 105 of any one row.

In accordance with this embodiment, it is possible to control the drive current to be exclusively supplied to the first amplification transistor 105 by controlling ON and OFF of the connection between the gate terminal of the first amplification transistor 105 and the ground using the switching transistor 113. Accordingly, it is possible to suppress an increase in current consumption. It is possible to suppress an increase in current consumption even when the current source 17 is turned on in all periods in which the operation related to the pixel 1 is performed without controlling ON and OFF of the current source 17 according to a variation in the switching pulse φSWT1. However, the certainty of the operation is further increased by controlling ON and OFF of the current source 17 as described above.

### Fourth Embodiment

Next, the fourth embodiment of the present invention will be described. In this embodiment, the configuration of the imaging unit 202 is different from that of the first embodiment. Hereinafter, the configuration of the pixel I will be described. Because the other configurations are substantially the same as those of the first embodiment, description thereof is omitted here.

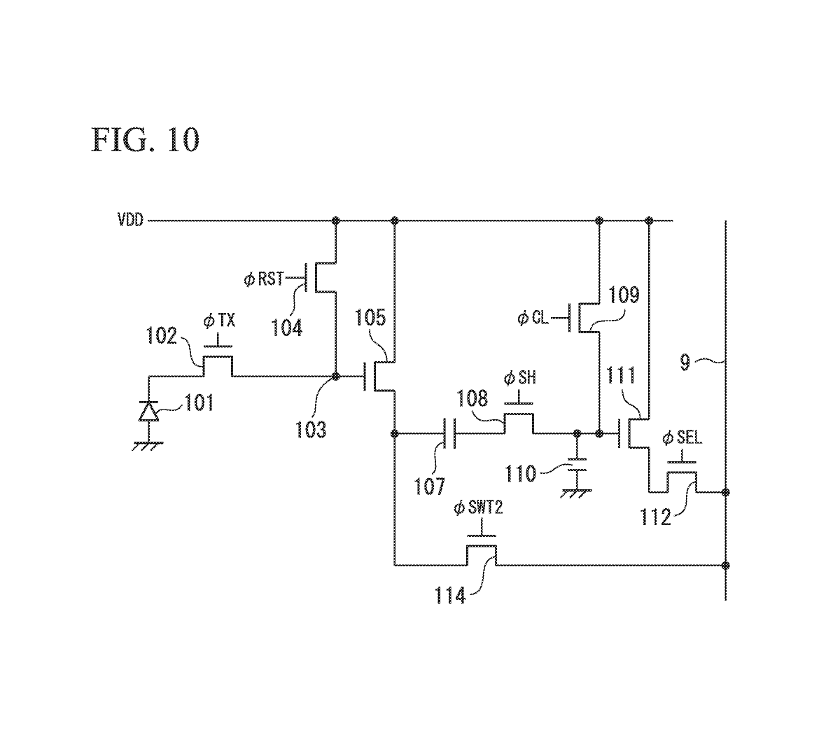

FIG. 10 illustrates a circuit configuration of the pixel 1 of this embodiment. Compared to the configuration illustrated in FIG. 4, the load transistor 106 is not provided in FIG. 10, and a switching transistor 114 is provided. The drain terminal of the switching transistor 114 is connected to the source terminal of the first amplification transistor 105 and one end of the clamping capacitor 107, and the source terminal of the switching transistor 114 is connected to the vertical signal line 9. The gate terminal of the switching transistor 114 is connected to the vertical scanning circuit 3, and supplied with a switching pulse φSWT2. The switching transistor 114 is a transistor that switches ON and OFF of a connection between the source terminal of the first amplification transistor 105 and the vertical signal line 9. ON and OFF of the switching transistor 114 are controlled by the switching pulse φSWT2 from the vertical scanning circuit 3. Because the configurations other than the above are substantially the same as the configurations illustrated in FIG. 4, description thereof is omitted here.

The pixel 1 of this embodiment belongs to a different column group for each column and a different row group for each row. Pixels 1 belonging to the same column constitute one column group. That is, pixels 1 of a first column constitute a first column group, pixels 1 of a second column constitute a second column group, pixels 1 of a third column constitute a third column group, . . . , and pixels 1 of an m^{th} column (last column) constitute an m^{th} column group. A drive current from the same current source 15 is supplied to the first amplification transistors 105 of the pixels 1 belonging to the same column group.

In addition, the pixel 1 belonging to the same column group constitutes one row group for each row. That is, among the pixels 1 belonging to the same column group, the pixel 1 of a first row constitutes a first row group, the pixel 1 of a second row constitutes a second row group, the pixel 1 of a third row constitutes a third row group, . . . , and the pixel 1 of an n^{th} row (last row) constitutes an n^{th} row group.

The majority of the operation of the pixel 1 in this embodiment is substantially the same as the operation illustrated in FIG. 6. A difference from the operation illustrated in FIG. 6 is that a switching pulse φSWT2 is supplied to the pixel 1 instead of the current control pulse φBias of FIG. 6. The switching pulse φSWT2 is at the “H” level during a period in which the current control pulse φBias of FIG. 6 is at the “H” level, and the switching pulse φSWT2 is at the “L” level during a period in which the current control pulse φBias is at the “L” level.

When the switching pulse φSWT2 is at the “H” level, the switching transistor 114 is turned on. Thereby, a connection between the source terminal of the first amplification transistor 105 and the current source 15 is turned on, and the drive current is supplied to the first amplification transistor 105. In addition, when the switching pulse φSWT2 is at the “L” level, the switching transistor 114 is turned off. Thereby, the connection between the source terminal of the first amplification transistor 105 and the current source 15 is turned off, and the supply of the drive current to the first amplification transistor 105 is stopped.

According to this embodiment, it is possible to control the drive current to be exclusively supplied to the first amplification transistor 105 by controlling ON and OFF of the connection between the source terminal of the first amplification transistor 105 and the current source 15 using the switching transistor 114. Accordingly, it is possible to suppress an increase in current consumption.

The amplification circuit (amplification transistor) in accordance with the present invention, for example, corresponds to the first amplification transistor 105. The signal accumulation circuit (memory circuit) in accordance with the present invention, for example, corresponds to the analog memory 110. The control unit in accordance with the present invention, for example, corresponds to the vertical scanning circuit 3, the load transistor 106, the changeover switch 12, and the switching transistors 113 and 114. In addition, the reset circuit in accordance with the present invention, for example, corresponds to the FD reset transistor 104, and the output circuit in accordance with the present invention, for example, corresponds to the selection transistor 112.

In addition, the first changeover switch (first switching transistor) in accordance with the present invention, for example, corresponds to the load transistor 106. The second changeover switch in accordance with the present invention, for example, corresponds to the changeover switch 12. The third changeover switch (second switching transistor) in accordance with the present invention, for example, corresponds to the switching transistor 113. The fourth changeover switch (third switching transistor) in accordance with the present invention, for example, corresponds to the switching transistor 114. In addition, the row signal line in accordance with the present invention corresponds to the power supply line 13, and the column signal line in accordance with the present invention corresponds to the vertical signal line 9. The clamping capacitor in accordance with the present invention, for example, corresponds to the clamping capacitor 107, and the transistor in accordance with the present invention, for example, corresponds to the sampling transistor 108.

Although the embodiments of the present invention have been described above in detail with reference to the drawings, specific configurations are not limited to the above-described embodiment, and various design changes may be made without departing from the spirit and scope of the present invention. Although the configuration of the solid-state imaging device in which the two substrates are connected by the connection unit has been described above, three or more substrates may be connected by the connection unit. In the case of a solid-state imaging device in which the three or more substrates are connected by the connection unit, two substrates of the three or more substrates correspond to the first substrate and the second substrate.

For example, a solid-state imaging device in accordance with an aspect of the present invention may be a solid-state imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion means arranged on the first substrate, an amplification means configured to output an amplified signal by amplifying a signal generated by the photoelectric conversion means, and a signal accumulation means arranged on the second substrate and configured to accumulate the amplified signal output from the amplification means; and a control means configured to control a drive current to be exclusively supplied to the amplification means of each of the first to n^{th} pixels.

For example, an image device in accordance with an aspect of the present invention may be an imaging device having electrically connected a first substrate and a second substrate on which circuit elements constituting pixels are arranged, including: a plurality of pixels classified as first to n^{th} (where n is an integer greater than or equal to 2) pixels, wherein each of the plurality of pixels includes a photoelectric conversion means arranged on the first substrate, an amplification means configured to output an amplified signal by amplifying a signal generated by the photoelectric conversion means, and a signal accumulation means arranged on the second substrate and configured to accumulate the amplified signal output from the amplification means; and a control means configured to control a drive current to be exclusively supplied to the amplification means of each of the first to n^{th} pixels.

A computer program product that implements any combination of components or processing processes described above is also valid as an aspect of the present invention. The computer program product refers to a recording medium, a device, equipment, or a system in which program codes are embedded such as a recording medium (a digital versatile disc (DVD) medium, a hard disk medium, a memory medium, or the like) recording program codes, a computer recording program codes, or an Internet system (for example, a system including a server and a client terminal) recording program codes. In this case, the components or processing processes described above are implemented by modules, and the program codes including the implemented modules are recorded within the computer program product.

For example, a computer program product in accordance with an aspect of the present invention may be a “computer program product recording program codes, including:

in each of a plurality of pixels classified as first to n^{th} (where n is an integer greater than or equal to 2) pixels,

a module, which outputs an amplified signal by amplifying a signal generated from a photoelectric conversion element arranged on the first substrate using an amplification circuit;

a module, which accumulates the amplified signal output from the amplification circuit in a signal accumulation circuit arranged on the second substrate; and

a module, which outputs the amplified signal accumulated in the signal accumulation circuit from the pixel, and

a module, which controls a drive current to be exclusively supplied to the amplification circuit within each of the first to n^{th} pixels.”

A program for implementing an arbitrary combination of components or processing processes according to the above-described embodiment is also effective as an aspect of the present invention. It is possible to achieve an object of the present invention by recording the above-described program on a computer-readable recording medium and causing a computer to read and execute the program recorded on the recording medium.

Here, the “computer” also includes a homepage providing environment (or displaying environment) if the World Wide Web (WWW) system is used. In addition, the “computer-readable recording medium” refers to a storage apparatus including a flexible disk, a magneto-optical disc, a ROM, a portable medium such as a compact disc-ROM (CD-ROM), and a hard disk embedded in the computer. Further, the “computer-readable recording medium” may also include a medium that holds a program for a constant period of time such as a volatile memory (for example, a random access memory (RAM)) in a computer system serving as a server or client when the program is transmitted via a network such as the Internet or a communication line such as a telephone line.

In addition, the above-described program may be transmitted from a computer in which this program has been stored in a storage apparatus and the like to another computer via a transmission medium or transmitted by waves in the transmission medium. Here, the “transmission medium” for transmitting a program refers to a medium that functions to transmit information as in a network (communication network) such as the Internet and a communication line (communication link) such as a telephone line. The above-described program may implement some of the above-described functions. Further, the above-described program may be a differential file (differential program) capable of implementing the above-described functions in combination with a program already recorded on the computer system.

Although the preferred embodiments of the present invention have been described, it is possible to use various alternatives, modifications and equivalents as various components or processing processes. To execute one or more functions in the embodiment disclosed in the present disclosure, one component may be replaced with a plurality of components, and a plurality of components may be replaced with one component. Such replacements are within the range of the present invention, except in cases in which such replacements do not appropriately function to achieve the object of the present invention. Therefore, the scope of the present invention should be determined with reference to the appended claims instead of being determined with reference to the above description, and includes all ranges of equivalents. In the claims, each number of components is one or more, unless expressly stated otherwise. The appended claims are not to be interpreted as including means-plus-function limitations, unless such a limitation is explicitly recited in a given claim using the phrase “means for.”

While the preferred embodiments of the present invention have been described above, the invention is not limited to these embodiments. Additions, omissions, substitutions, and other modifications may be made without departing from the spirit or scope of the present invention. Accordingly, the present invention is not to be considered as being limited by the foregoing description, and is only limited by the scope of the appended claims.

What is claimed is:

1. A solid-state imaging device having electrically connected a first substrate and a second substrate on which circuit elements constituting pixels are arranged, the solid-state imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification circuit configured to output an amplified signal by amplifying a signal generated by the photoelectric conversion element, and
a signal accumulation circuit arranged on the second substrate and configured to accumulate the amplified signal output from the amplification circuit; and
a control unit configured to control a drive current to be exclusively supplied to the amplification circuit of each of the first to n^{th} pixels.

2. The solid-state imaging device according to claim 1, wherein the plurality of pixels are classified as the first to n^{th} pixels based on arrangement positions of the plurality of pixels.

3. The solid-state imaging device according to claim 2, wherein the plurality of pixels are arranged in a matrix, the plurality of pixels are classified into one or more groups for each column, and pixels within the same group are classified as the first to n^{th} pixels.

4. The solid-state imaging device according to claim 2, further comprising:
a reset circuit configured to reset the photoelectric conversion element, wherein the plurality of pixels are arranged in a matrix,
and
the signal accumulation circuit sequentially performs an operation of accumulating the amplified signal corresponding to the signal generated by the photoelectric conversion element in unit of row after the reset circuit has reset the photoelectric conversion element.

5. The solid-state imaging device according to claim 4, further comprising:
an output circuit configured to output the amplified signal accumulated in the signal accumulation circuit from the pixel,
wherein, after amplified signals have been transferred to signal accumulation circuits of all pixels, the output circuit sequentially performs an operation of outputting the amplified signals from the pixels in unit of row.

6. The solid-state imaging device according to claim 4, wherein the control unit selects one of the first to n^{th} pixels and turns on a drive current for the amplification circuit in the selected pixel during at least one period of a period in which the photoelectric conversion element generates the signal after the reset and a period in which the signal accumulation circuit accumulates the amplified signal corresponding to the signal generated by the photoelectric conversion element, and controls the drive current for the amplification circuit to be turned off during a period in which the amplified signal is output from the pixel.

7. The solid-state imaging device according to claim 6, wherein the control unit has a first changeover switch connected to an output unit of the amplification circuit and a ground, and configured to switch ON and OFF of the connection between the output unit of the amplification circuit and the ground.

8. The solid-state imaging device according to claim 7, wherein the first changeover switch turns on the connection between the output unit of the amplification circuit and the ground when the drive current for the amplification circuit is turned on, and turns off the connection between the output unit of the amplification circuit and the ground when the drive current for the amplification circuit is turned off.

9. The solid-state imaging device according to claim 6, wherein:
the amplification circuit is connected to a row signal line arranged for each row; and
the control unit has a second changeover switch connected to a power supply for supplying a voltage and the row signal line and configured to switch ON and OFF of a connection between the power supply and the row signal line.

10. The solid-state imaging device according to claim 9, wherein the second changeover switch turns on a connection between the power supply and the row signal line when a drive current for the amplification circuit is turned on, and turns off the connection between the power supply and the row signal line when the drive current for the amplification circuit is turned off.

11. The solid-state imaging device according to claim 6, wherein the control unit includes:
a third changeover switch connected to an input unit of the amplification circuit and a ground and configured to switch ON and OFF of a connection between the input unit of the amplification circuit and the ground.

12. The solid-state imaging device according to claim 11, wherein the third changeover switch turns off the connection between the input unit of the amplification circuit and the ground when the drive current for the amplification circuit is turned on, and turns on the connection between the input unit of the amplification circuit and the ground when the drive current for the amplification circuit is turned off.

13. The solid-state imaging device according to claim 6, wherein:
the amplification circuit is connected to a column signal line arranged for each column, wherein the column signal line is connected to a current source for supplying the drive current; and
the control unit has a fourth changeover switch connected to an output unit of the amplification circuit and the column signal line and configured to switch ON and OFF of a connection between the output unit of the amplification circuit and the column signal line.

14. The solid-state imaging device according to claim 13, wherein:
the fourth changeover switch turns on the connection between the output unit of the amplification circuit and the column signal line when the drive current for the amplification circuit is turned on, and turns off the connection between the output unit of the amplification circuit and the column signal line when the drive current for the amplification unit is turned off.

15. A solid-state imaging device having electrically connected a first substrate and a second substrate on which circuit elements constituting pixels are arranged, comprising:
a plurality of pixels classified as first to n^{th} (where n is an integer greater than or equal to 2) pixels,
wherein each of the plurality of pixels includes
a photoelectric conversion element arranged on the first substrate,
an amplification transistor configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a first switching transistor having one of a source and a drain connected to the output terminal of the amplification transistor and the other of the source and the drain connected to a ground, and configured to switch ON and OFF of a connection between the output terminal of the amplification transistor and the ground and exclusively supply a drive current to the amplification transistor within each of the first to n^{th} pixels.

16. The solid-state imaging device according to claim 15, further comprising:
a clamping capacitor configured to clamp the amplified signal output from the amplification transistor; and
a transistor configured to receive a signal corresponding to the amplified signal clamped by the clamping capacitor using one of the source and the drain and accumulate the signal received using one of the source and the drain in the memory circuit by sampling and holding the signal.

17. The solid-state imaging device according to claim 16, wherein the first and the second substrates are electrically connected via a connection unit.

18. The solid-state imaging device according to claim 17, wherein the connection unit is arranged between the photoelectric conversion element and the amplification transistor, between the amplification transistor and the clamping capacitor, between the clamping capacitor and the transistor, or between the transistor and the memory circuit on a path electrically connected from the photoelectric conversion element to the memory circuit.

19. A solid-state imaging device having electrically connected a first substrate and a second substrate on which circuit elements constituting pixels are arranged, the solid-state imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor connected to a row signal line arranged for each row and configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a changeover switch having one end connected to a power supply for supplying a voltage and the other end connected to the row signal line and configured to switch ON and OFF of a connection between the power supply and the row signal line and exclusively supply a drive current to the amplification transistor within each of the first to n^{th} pixels.

20. A solid-state imaging device having electrically connected a first substrate and a second substrate on which circuit elements constituting pixels are arranged, the solid-state imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a second switching transistor having one of a source and a drain connected to a gate of the amplification transistor and the other of the source and the drain connected to a ground and configured to switch ON and OFF of a connection between the gate of the amplification transistor and the ground and exclusively supply a drive current to the amplification transistor within each of the first to n^{th} pixels.

21. A solid-state imaging device having electrically connected a first substrate and a second substrate on which circuit elements constituting pixels are arranged, the solid-state imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor connected to a column signal line arranged for each column connected to a current source for supplying a drive current and configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a third switching transistor having one of a source and a drain connected to the output terminal of the amplification transistor and the other of the source and the drain connected to the column signal line and configured to switch ON and OFF of a connection between the output terminal of the amplification transistor and the column signal line and exclusively supply the drive current to the amplification transistor within each of the first to n^{th} pixels.

22. An imaging device having electrically connected a first substrate and a second substrate on which circuit elements constituting pixels are arranged, the imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification circuit configured to output an amplified signal by amplifying a signal generated by the photoelectric conversion element, and
a signal accumulation circuit arranged on the second substrate and configured to accumulate the amplified signal output from the amplification circuit; and
a control unit configured to control a drive current to be exclusively supplied to the amplification circuit within each of the first to n^{th} pixels.

23. An imaging device having electrically connected a first substrate and a second substrate on which circuit elements constituting pixels are arranged, the imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a first switching transistor having one of a source and a drain connected to the output terminal of the amplification transistor and the other of the source and the drain connected to a ground, and configured to switch ON and OFF of a connection between the output terminal of the amplification transistor and the ground and exclusively supply a drive current to the amplification transistor within each of the first to n^{th} pixels.

24. An imaging device having electrically connected a first substrate and a second substrate on which circuit elements constituting pixels are arranged, the imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor connected to a row signal line arranged for each row and configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a changeover switch having one end connected to a power supply for supplying a voltage and the other end connected to the row signal line and configured to switch ON and OFF of a connection between the power supply and the row signal line and exclusively supply a drive current to the amplification transistor within each of the first to n^{th} pixels.

25. An imaging device having electrically connected a first substrate and a second substrate on which circuit elements constituting pixels are arranged, the imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a second switching transistor having one of a source and a drain connected to a gate of the amplification transistor and the other of the source and the drain connected to a ground and configured to switch ON and OFF of a connection between the gate of the amplification transistor and the ground and exclusively supply a drive current to the amplification transistor within each of the first to n^{th} pixels.

26. An imaging device having electrically connected a first substrate and a second substrate on which circuit elements constituting pixels are arranged, the imaging device comprising:
a plurality of pixels classified as first to n^{th} (where n is an integer greater than or equal to 2) pixels,
wherein each of the plurality of pixels includes
a photoelectric conversion element arranged on the first substrate,
an amplification transistor connected to a column signal line arranged for each column connected to a current source for supplying a drive current and configured to receive a signal generated by the photoelectric conversion element using a gate, amplify the signal received by the gate, and output the amplified signal from an output terminal, which is one of a source and a drain, and
a memory circuit arranged on the second substrate and configured to accumulate the amplified signal output from the amplification transistor; and
a third switching transistor having one of a source and a drain connected to the output terminal of the amplification transistor and the other of the source and the drain connected to the column signal line and configured to switch ON and OFF of a connection between the output terminal of the amplification transistor and the column signal line and exclusively supply the drive current to the amplification transistor within each of the first to n^{th} pixels.

27. A signal reading method of reading signals from pixels of a solid-state imaging device having electrically connected a first substrate and a second substrate on which circuit elements constituting the pixels are arranged, the signal reading method comprising the steps of:
in each of a plurality of pixels classified as first to n^{th} (where n is an integer greater than or equal to 2) pixels,
outputting an amplified signal by amplifying a signal generated from a photoelectric conversion element arranged on the first substrate using an amplification circuit;
accumulating the amplified signal output from the amplification circuit in a signal accumulation circuit arranged on the second substrate; and
outputting the amplified signal accumulated in the signal accumulation circuit from the pixel,
wherein a drive current is controlled to be exclusively supplied to the amplification circuit within each of the first to n^{th} pixels.
